(19) United States
(12) Patent Application Publication
(10) Pub. No.: US 2008/0099345 A1
(43) Pub. Date: May 1, 2008

(54) ELECTROPOLISHING PROCESS FOR NIOBIUM AND TANTALUM

(75) Inventors: Siegfried Piesslinger-Schweiger, Vaterstetten (DE); Olaf Bohme, Erding (DE)

Correspondence Address: BORDEN LADNER GERVAIS LLP;Gail C. Silver, 1100-100 QUEEN ST, OTTAWA, ON, K1P 1J9, CA

(73) Assignee: POLIGRAT GmbH, Munich (DE)

(21) Appl. No.: 11/869,383

(22) Filed: Oct. 9, 2007

(30) Foreign Application Priority Data
Oct. 9, 2006 (DE) 102006047713.8

(51) Int. Cl. B23H 3/00

(52) U.S. Cl. 205/684

(57) ABSTRACT

The present invention relates to a method for the electrochemical polishing of surfaces of metals and metal alloys, in particular surfaces of niobium, niobium alloys, tantalum and tantalum alloys. It uses an electrolyte that comprises methanesulfonic acid and ammonium bifluoride, and which is also an object of the present invention. Said electrolyte makes it possible to electropolish niobium-containing and/or tantalum-containing workpieces efficiently, with high quality and in a manner that is harmless both for the workpiece and for humans and the environment.

The present invention relates to a method for the electrochemical polishing of surfaces of metals and metal alloys, in particular of metals and metal alloys that are selected from the group comprising niobium, niobium alloys, tantalum and tantalum alloys. In addition, the present invention relates to an electrolyte for the electropolishing of surfaces of said metals and metal alloys. Said electrolyte contains methanesulfonic acid and ammonium bifluoride, NH₄HF₂.

### BACKGROUND OF THE INVENTION

The purpose of the process of electrochemical polishing or electropolishing is to produce metal surfaces of high purity, and to smooth and deburr metal surfaces. Smoothing in the micro-range has the effect that the surfaces so treated have a high gloss. In addition, electropolishing can remove stresses in the outer layers of material. A great many different electropolishing processes are known in the state of the art, and can be used for processing various metals and metal alloys. As a rule these methods are based on the use of electrolytes, which contain a concentrated inorganic acid or a mixture of concentrated inorganic acids, often also containing additives to further enhance the action of the electrolytes, and so obtain smoother and shinier metal surfaces.

Nuclear research installations also impose high requirements on metal surfaces with respect to their purity and low outgassing rates under vacuum, so that the processes and measurements taking place in the installations can be carried out under the maximum possible control. In order to satisfy these requirements, the metal surfaces of workpieces that are to be used in these and similar applications must as a rule be electropolished to a high quality.

For most of the metals and metal alloys used in these applications, such as special steels, titanium and aluminum, electropolishing processes are available that have been tested industrially and offer good operational reliability. Niobium, in contrast, cannot be processed satisfactorily at reasonable environmental impact with the electropolishing processes known hitherto.

However, niobium and tantalum are used, on account of their high thermal stability, both as pure metals and as constituents of alloys with one another and/or with other metals, in the production of components, for example of gas turbines or in engine building.

According to the present state of the art, a method is used for the electropolishing of niobium that employs an electrolyte comprising a mixture of concentrated sulfuric acid and hydrofluoric acid at a ratio of about 90:10. However, in the course of the electropolishing process, this electrolyte releases large amounts of gaseous hydrogen fluoride, which is toxic and corrosive. Therefore, in order to keep the risks for humans and the environment low, this process can only be carried out under stringent, extremely expensive safety measures. A further disadvantage of this process is that said electrolyte also attacks the niobium surface chemically, in particular even when the flow of current is interrupted. Appreciable amounts of hydrogen are then released, which partly also diffuse into the metal surface and must then be removed again at considerable expense by heating under vacuum. To minimise the chemical attack of the electrolyte on the electropolished surface, the workpieces being processed must therefore be removed from the bath generally very quickly after switching off the current, i.e. within a few seconds, and then rinsed completely. This quick rinsing often requires special equipment and thus also involves high cost. Therefore the process quickly comes up against its limits especially in the processing of larger components, and only finds limited application.

Patent application WO 01/71068 A1 discloses electrolytic polishing processes, in which tantalum and niobium, among others, are electropolished with an electrolyte of methanesulfonic acid and methanol. Although this electropolishing process evidently gives good results for tantalum, no information is given at all concerning the quality of the electropolishing process in the processing of niobium surfaces. Japanese patent application JP 60092500 A2 uses a mixture of sulfuric acid and fluorosulfonic acid. Admittedly no toxic hydrogen fluoride gases are released, but the use of fluorosulfonic acid is extremely complex and expensive owing to the high reactivity, so as largely to avoid contact between fluorosulfonic acid and air, as this too can generate toxic vapours.

There is therefore a great need for an electropolishing process by which niobium-containing surfaces can also be smoothed and deburred efficiently and at high quality, without exposing humans and the environment to any significant pollution and hazards.

### BRIEF DESCRIPTION OF THE DIAGRAMS

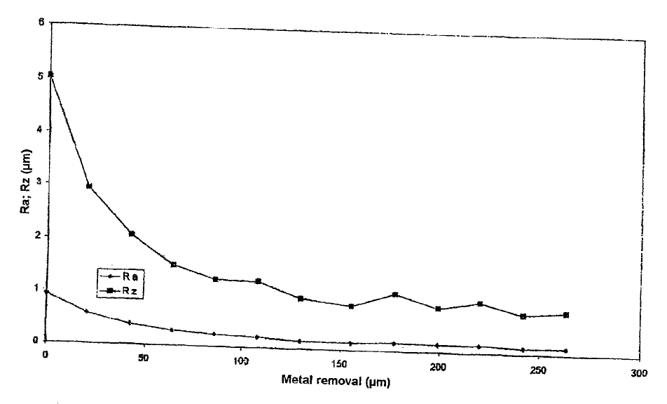

FIG. 1 shows the decrease in the roughness values Ra and Rz in the electropolishing of a sheet of pure niobium using the method according to the present invention (cf. Example 1).

### DESCRIPTION OF THE INVENTION

The present invention relates to a method for the electropolishing of surfaces of metals and metal alloys, which is suitable in particular for the processing of surfaces of niobium, niobium alloys, tantalum and tantalum alloys. Niobium and tantalum alloys are to be understood both as solid-phase mixtures and compounds of niobium and tantalum with each other and of one or both metals with other elements, which have a metallic character or also form intermetallic compounds. The application of this method is largely without danger for humans and the environment. This electropolishing process uses an electrolyte that contains methanesulfonic acid and ammonium bifluoride (ammonium hydrogen difluoride, NH₄⁺HF₂⁻). This electrolyte is also an object of the present invention.

Preferably the concentration of the methanesulfonic acid used in the electrolyte is greater than 80%. This figure refers—like all other values shown in the present application, unless stated otherwise—to the weight of the respective substances and solutions. An electrolyte in which the concentration of methanesulfonic acid in the electrolyte is at least 90% is especially preferred.

In one embodiment the concentration of ammonium hydrogen difluoride in the electrolyte is between 5 and 100 g/l, preferably between 20 and 70 g/l. If the metal surface is a surface of niobium or a niobium alloy it is especially preferred for the concentration of ammonium hydrogen difluoride in the electrolyte to be approx. 40 g/l. If the metal surface consists primarily or exclusively of tantalum or a tantalum alloy, the best results can be obtained at a concentration of ammonium hydrogen difluoride in the electrolyte of about 60 g/l.

In a further preferred embodiment, the electrolyte does not contain any other acids apart from methanesulfonic acid. In particular the electrolyte used here does not contain any appreciable amounts of phosphoric acid, sulfuric acid, nitric acid and free hydrofluoric acid. Thus, an electrolyte according to the present invention can form as it were a binary system comprising only methanesulfonic acid and ammonium bifluoride.

It was found, surprisingly, that using an electrolyte according to the present invention it is possible to electropolish surfaces of metals and metal alloys, and in particular those consisting essentially of niobium and/or tantalum, and in this way obtain surfaces with excellent smoothness and deburring. It was surprising, in particular, that this electrolyte does not attack the niobium-containing surfaces chemically during the electropolishing operation or after switching off the current, and thus there is no release of hydrogen that could diffuse into the metal surface. Thus, in the electropolishing process described here, the rinsing of the processed workpieces does not have to be carried out within a few seconds, but can take place in a period of time that is usual in the electropolishing processes commonly used for other metals. This also permits, for the first time, problem-free electrochemical polishing of surfaces of larger components or of components with surfaces that are difficult to rinse.

Especially high-gloss and microsmooth surfaces of niobium, niobium alloys, tantalum and tantalum alloys are obtained if the method is carried out at an anodic current density from 5 to 25 A/dm². Under these conditions, no selective attack of the electrolyte at the grain boundaries of the metal structure is observed. The method is preferably carried out at approx. 10 A/dm².

Usually the method according to the invention is carried out at a temperature between 10° C. and 50° C. After switching off the current, the electrolyte can remain on the electropolished surfaces of the components for quite a considerable time without risk, and then rinsed away with water, without the surfaces being attacked in any of the process steps.

A substantial advantage in employing the method described here is that no special measures are required for protection of humans and the environment. In contrast to the electrolytes used in the state of the art, an electrolyte that contains methanesulfonic acid and ammonium bifluoride can be handled without applying safety precautions beyond the usual safety measures for the handling of strong concentrated acids. In particular, with an electrolyte according to the present invention there is no evolution of hydrogen fluoride gas from the electrolyte. The fluoride ions from the ammonium hydrogen difluoride are bound chemically by the metal that is removed in the course of the electropolishing process.

The invention is explained in more detail in the following examples. These examples only represent possible embodiments of the electropolishing process described here, and do not in any way imply a restriction to the conditions used here.

### EXAMPLES

### Example 1

### Electropolishing of Niobium

Prior to electropolishing, a sheet of pure niobium was submitted to alkaline degreasing, rinsed in water and dried. The following electropolishing variables were used:

Material: pure niobium (sheet with thickness of 1.2 mm)

Electrolyte: methanesulfonic acid+30 g/l ammonium hydrogen difluoride

Bath temperature: 30° C.

Current density: 10 A/dm²

Polishing time: 12 minutes

After electropolishing, the sheet was rinsed in demineralized water and dried in air.

Result: high-gloss surface; the roughness values Ra and Rz are more than 60% lower, relative to the initial condition of the material (cf. FIG. 1).

### Example 2

### Electropolishing of Tantalum

A tantalum sheet was submitted to alkaline degreasing, rinsed in water and dried prior to electropolishing. The following electropolishing variables were used:

Material: tantalum (sheet with thickness of 0.5 mm)

Electrolyte: methanesulfonic acid+60 g/l ammonium hydrogen difluoride

Bath temperature: 30° C.

Current density: 13 A/dm²

Polishing time: 10 minutes

After electropolishing, the sheet was rinsed in demineralized water and dried in air.

Result: high-gloss surface

What is claimed is:

1. An electrolyte for the electropolishing of surfaces of metals and metal alloys that are selected from the group comprising niobium, niobium alloys, tantalum and tantalum alloys, wherein the electrolyte comprises methanesulfonic acid and ammonium bifluoride.

2. The electrolyte as claimed in claim 1, wherein the concentration of the methanesulfonic acid used is greater than 80 wt. %.

3. The electrolyte as claimed in claim 1, wherein the concentration of methanesulfonic acid in the electrolyte is at least 90 wt. %.

4. The electrolyte as claimed in claim 1, wherein the concentration of ammonium bifluoride in the electrolyte is between 5 and 100 g/l.

5. The electrolyte as claimed in claim 1, wherein the concentration of ammonium bifluoride in the electrolyte is between 20 and 70 g/l.

6. The electrolyte as claimed in claim 1, wherein the concentration of ammonium bifluoride in the electrolyte is about 40 g/l, and the surface comprises niobium or a niobium alloy.

7. The electrolyte as claimed in claim 1, wherein the concentration of ammonium bifluoride in the electrolyte is about 60 g/l, and the surface comprises tantalum or a tantalum alloy.

8. The electrolyte as claimed in claim 1, wherein the electrolyte does not contain any other acids.

9. The electrolyte as claimed in claim 1, wherein the electrolyte consists essentially of methanesulfonic acid and ammonium bifluoride.

10. The electrolyte as claimed in claim 1, wherein the electrolyte consists of methanesulfonic acid and ammonium bifluoride.

11. A method of electropolishing of surfaces of metals and metal alloys with an electrolyte as claimed in claim 1.

12. The method as claimed in claim 11, wherein the metals and metal alloys comprise substantially niobium and/or tantalum.

13. The method as claimed in claim 11, wherein the method is carried out at a temperature between 10° C. and 50° C.

14. The method as claimed in claim 11, wherein the method is carried out at an anodic current density from 5 to 25 A/dm².

15. The method as claimed in claim 11, wherein the method is carried out at an anodic current density of about 10 A/dm².
